(19) United States
(12) Patent Application Publication
(10) Pub. No.: US 2011/0107137 A1
(43) Pub. Date: May 5, 2011

(54) System and method for providing automated support to electronic devices

(75) Inventors: Tom Lam, Chula Vista, CA (US); Robert Cowie, Escondido, CA (US); Tam Dao, San Marcos, CA (US); Anh La, Singapore (SG); Don Nguyen, San Marcos, CA (US); Guoxuan Zhang, San Diego, CA (US)

(73) Assignee: Sony Corporation

(21) Appl. No.: 12/590,271

(22) Filed: Nov. 5, 2009

(51) Int. Cl. G06F 11/07; G06F 11/00

(52) U.S. Cl. 714/4.4; 714/E11.023

(57) ABSTRACT

A system and method for providing automated support services includes at least one electronic device that experiences an error condition. An error notification regarding the error condition is then provided to a support server. The support server assigns an error identifier to the error condition, and provides the error identifier to the electronic device. The support server also creates a solution map that associates the error identifier with a solution identifier corresponding to an effective solution for the detected error condition. A solution database is implemented to store the solution to the error condition. A solution manager of the electronic device may then utilize the error identifier to automatically identify, download, and install the solution from the solution database to thereby remedy the error condition.

### BACKGROUND SECTION

1. Field of the Invention

This invention relates generally to techniques for managing electronic devices, and relates more particularly to a system and method for effectively providing automated support to electronic devices.

2. Description of the Background Art

Implementing effective methods for supporting electronic devices is a significant consideration for designers and manufacturers of contemporary electronic systems. However, effectively supporting electronic devices may create substantial challenges for system designers. For example, enhanced demands for increased device functionality and performance may require more system processing power and require additional software resources. An increase in processing or software requirements may also result in a corresponding detrimental economic impact due to increased production costs and operational inefficiencies.

Furthermore, enhanced device capability to perform various advanced functions may provide additional benefits to a system user, but may also place increased demands on the control and management of various system components. For example, an enhanced electronic network device that effectively supports software applications may benefit from an effective implementation because of the large amount and complexity of the digital data involved.

Due to growing demands on system resources and substantially increasing data magnitudes, it is apparent that developing new techniques for supporting electronic devices is a matter of concern for related electronic technologies. Therefore, for all the foregoing reasons, developing effective techniques for providing support services remains a significant consideration for designers, manufacturers, and users of contemporary electronic devices.

### SUMMARY

In accordance with the present invention, a system and method for effectively providing automated support to electronic devices are disclosed. In one embodiment, an error condition initially occurs in an electronic device that has authorized access to an automated device support system. The error may include any type of occurrence, condition, or state that affects the electronic device. In certain embodiments, an error manager of the electronic device detects the foregoing error condition.

An error notification is provided to a support server of the automated device support system in any effective manner. For example, a device user of the electronic device may manually provide the error notification by any means including, but not limited to, a telephone conversation or an email message. Alternately, the error manager may automatically provide the error notification to the support server via an Internet or other type of communication link.

A support manager of the support server then updates an error database to include a unique error identifier (ID) corresponding to the detected error on the electronic device. The support server also provides a copy of the error ID to the electronic device for local storage in a list of detected errors. In certain embodiments, support system personnel or other appropriate entities periodically evaluate the error database of the support server to identify any new detected errors. The support system personnel or other appropriate entities then work to develop an effective solution for correcting any new detected errors.

The support manager of the support server next performs a mapping procedure to populate a solution map on the support server. In certain embodiments, the solution map associates each error ID with a corresponding solution identifier (ID) that represents an effective solution for that particular detected error. The support system personnel or other appropriate entities also store the developed solution in a solution database of a solution server.

In certain embodiments, a solution manager of the electronic device may query the solution map of the support server to determine whether an effective solution is listed for any of the locally-stored detected errors. In one embodiment, the solution manager compares the locally-stored error IDs with the error IDs in the solution map on the support server. If one or more matching error IDs are identified, then the support manager of the electronic device may utilize solution IDs corresponding to those matching error IDs to access and download appropriate solutions from the solution database of the solution server. The solution manager then installs the downloaded solutions to effectively remedy the detected errors on the electronic device. For at least the foregoing reasons, the present invention therefore provides an improved system and method for effectively providing automated support to electronic devices.

### BRIEF DESCRIPTION OF THE DRAWINGS

FIG. 1 is a block diagram of a support system, in accordance with one embodiment of the present invention;

FIG. 2 is a block diagram for one embodiment of the support server of FIG. 1, in accordance with the present invention;

FIG. 3 is a block diagram for one embodiment of the server memory of FIG. 2, in accordance with the present invention;

FIG. 4 is a block diagram of a solution map from FIG. 3, in accordance with one embodiment of the present invention;

FIG. 5 is a block diagram for one embodiment of the electronic device from FIG. 1, in accordance with the present invention;

FIG. 6 is a block diagram for one embodiment of the device memory of FIG. 5, in accordance with the present invention; and

FIG. 7 is a block diagram for one embodiment of the detected errors from FIG. 6, in accordance with the present invention;

FIG. 8 is a block diagram for one embodiment of a solution database, in accordance with the present invention; and

FIGS. 9A-9C are a flowchart of method steps for providing automated support to an electronic device, in accordance with one embodiment of the present invention.

### DETAILED DESCRIPTION

The present invention relates to an improvement in device support techniques. The following description is presented to enable one of ordinary skill in the art to make and use the invention, and is provided in the context of a patent application and its requirements. Various modifications to the disclosed embodiments will be readily apparent to those skilled in the art, and the generic principles herein may be applied to other embodiments. Therefore, the present invention is not intended to be limited to the embodiments shown, but is to be accorded the widest scope consistent with the principles and features described herein.

The present invention comprises a system and method for providing automated support services, and includes at least one electronic device that experiences an error condition. An error notification regarding the error condition is then provided to a support server. The support server assigns an error identifier to the error condition, and provides the error identifier to the electronic device. The support server also creates a solution map that associates the error identifier with a solution identifier corresponding to an effective solution for the detected error condition. A solution database is implemented to store the solution to the error condition. A solution manager of the electronic device may then utilize the error identifier to automatically identify, download, and install the solution from the solution database to thereby remedy the error condition.

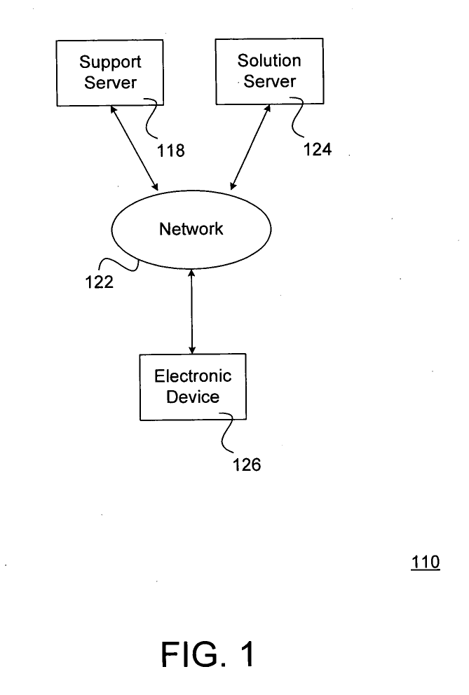

Referring now to FIG. 1, a block diagram of a support system 110 is shown, in accordance with one embodiment of the present invention. In the FIG. 1 embodiment, support system 110 may include, but is not limited to, a support server 118, a network 122, a solution server 124, and at least one electronic device 126. In alternate embodiments, support system 110 may be implemented by utilizing components and configurations in addition to, or instead of, certain of those components and configurations discussed in conjunction with the FIG. 1 embodiment. For purposes of simplicity, the FIG. 1 embodiment shows only one electronic device 126. However, the present invention contemplates utilizing support system 110 to support any desired number of additional electronic devices 126 in a similar manner.

In the FIG. 1 embodiment, electronic device 126 may experience various types of error conditions (errors) that prevent electronic device 126 from operating in a normal manner. These errors may include any types of events, states, or occurrences. For example, electronic device 126 may experience and detect an error that is cause by software, hardware, or network problems. In one instance, an error may include a “crash” state in which a software application executing on electronic device 126 encounters an operational problem that causes electronic device 126 to be unable to perform normal operating functions.

In the FIG. 1 embodiment, support server 118 is notified regarding the detected error on electronic device 126 by utilizing any effective means. For example, electronic device 126 may automatically detect and notify support server 118 through network 122. Alternately, a device user of electronic device 126 may personally provide information regarding the detected error to support server 118 by contacting support personnel by telephone, email, or other appropriate means. In the FIG. 1 embodiment, network 122 may be implemented in any effective manner. For example, network 122 may include, but is not limited to, the Internet.

In the FIG. 1 embodiment, the detected error is assigned a unique error identifier (ID) by the support server 118, and support personnel work to develop an effective solution for the detected error. Once a solution has been discovered, a solution ID for the solution is entered in a solution map together with the corresponding error ID. The solution may then be uploaded with the solution ID to a solution database on the solution server 124 for manual access by authorized device users.

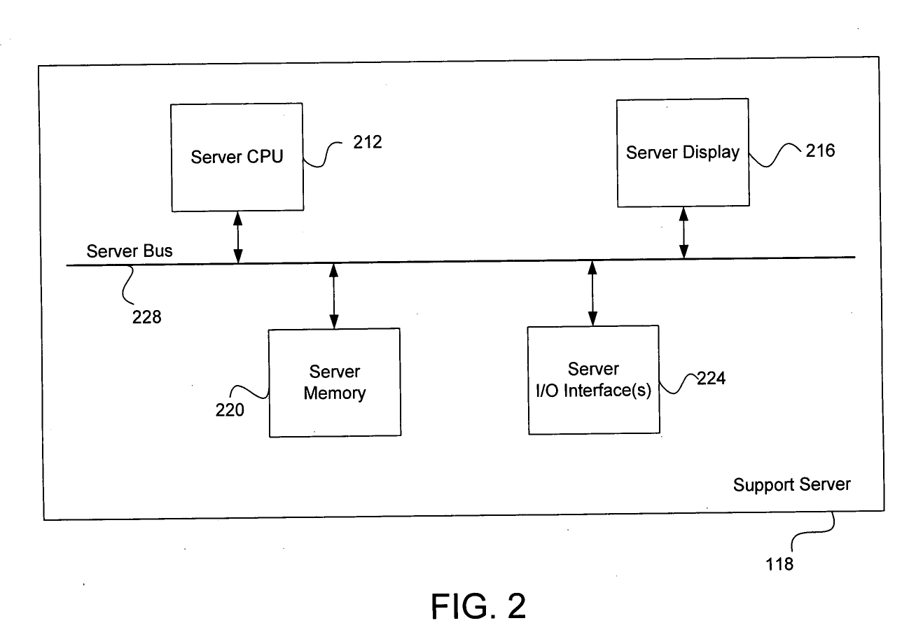

In accordance with the present invention, a solution manager of the electronic device 126 may automatically query the solution map on the support server 118 to determine whether an appropriate solution is available for the detected error. If such a solution is available, then the solution manager may automatically access the solution database on the solution server 124 to download and install the solution. For at least the foregoing reasons, the present invention therefore provides an improved system and method for effectively providing automated support to electronic devices 126. Additional details regarding these device support procedures are further discussed below in conjunction with FIGS. 2-9

Referring now to FIG. 2, a block diagram for one embodiment of the FIG. 1 support server 118 is shown, in accordance with the present invention. In the FIG. 2 embodiment, support server 118 includes, but is not limited to, a server central processing unit (server CPU) 212, a server display 216, a server memory 220, and one or more server input/output interface(s) (server I/O interface(s)) 224. The foregoing components of support server 118 may be coupled to, and communicate through, a server bus 228. In alternate embodiments, support server 118 may alternately be implemented using components and configurations in addition to, or instead of, certain of those components and configurations discussed in conjunction with the FIG. 2 embodiment.

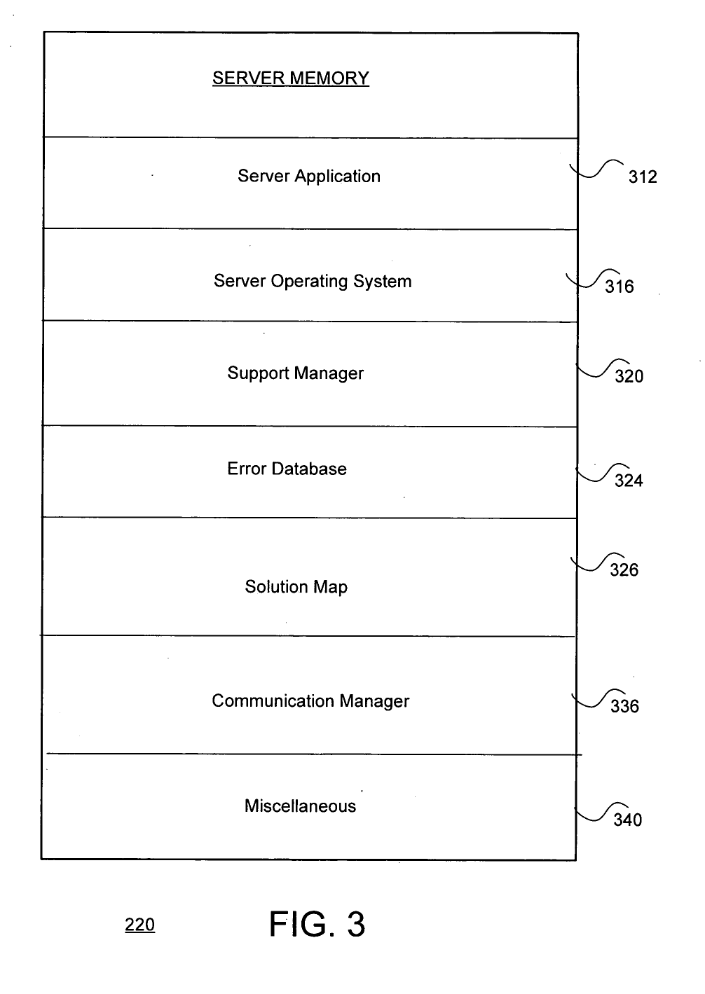

In the FIG. 2 embodiment, server CPU 212 may be implemented to include any appropriate and compatible microprocessor device that preferably executes software instructions to thereby control and manage the operation of support server 118. The FIG. 2 server display 216 may include any effective type of display technology including a cathode-ray-tube monitor or a liquid-crystal display device with an appropriate screen for displaying various information to a server user. In the FIG. 2 embodiment, server memory 220 may be implemented to include any combination of desired storage devices, including, but not limited to, read-only memory (ROM), random-access memory (RAM), and various types of non-volatile memory, such as floppy disks, memory sticks, compact disks, or hard disks. The contents and functionality of server memory 220 are further discussed below in conjunction with FIG. 3.

In the FIG. 2 embodiment, server I/O interface(s) 224 may include one or more input and/or output interfaces to receive and/or transmit any required types of information by support server 118. Server I/O interface(s) 224 may include one or more means for allowing a server user to communicate with support server 118. In certain embodiments of the FIG. 1 support system 110, the solution server 124 may be implemented using configurations that are the same or similar to those discussed herein in conjunction with support server 118. The utilization of support server 118 is further discussed below in conjunction with FIGS. 3-4 and 9.

Referring now to FIG. 3, a block diagram for one embodiment of the FIG. 2 server memory 220 is shown, in accordance with the present invention. In the FIG. 3 embodiment, server memory 220 may include, but is not limited to, a server application 312, a server operating system 316, a support manager 320, an error database 324, a solution map 326, a communication manager 336, and miscellaneous information 340. In alternate embodiments, server memory 220 may include various other components and functionalities in addition to, or instead of, certain those components and functionalities discussed in conjunction with the FIG. 3 embodiment.

In the FIG. 3 embodiment, server application 312 may include program instructions that are preferably executed by server CPU 212 (FIG. 2) to perform various functions and operations for support server 118. The particular nature and functionality of server application 312 typically varies depending upon factors such as the specific type and particular functionality of the corresponding support server 118. Server operating system 316 may perform various low-level functions for support server 118.

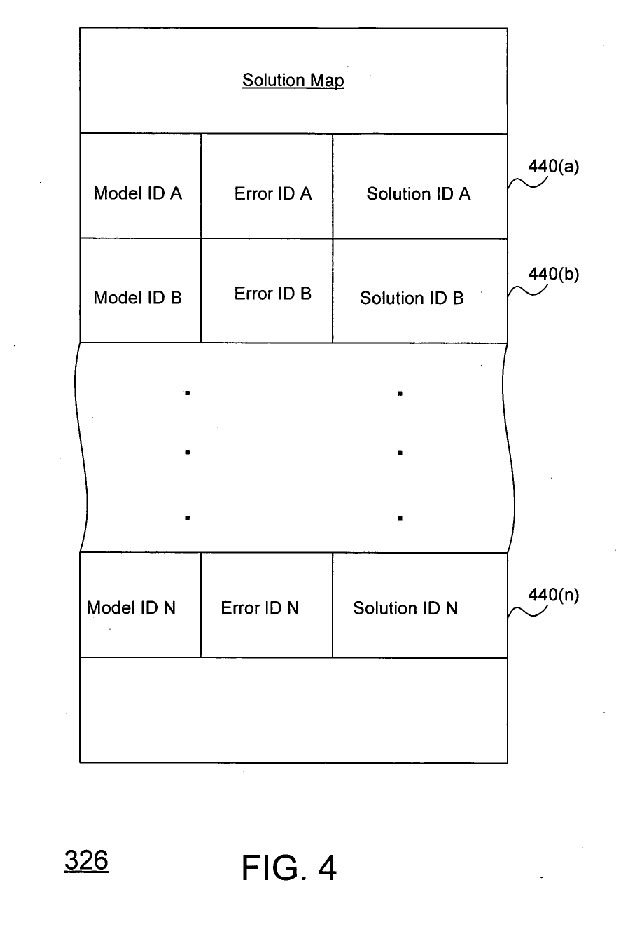

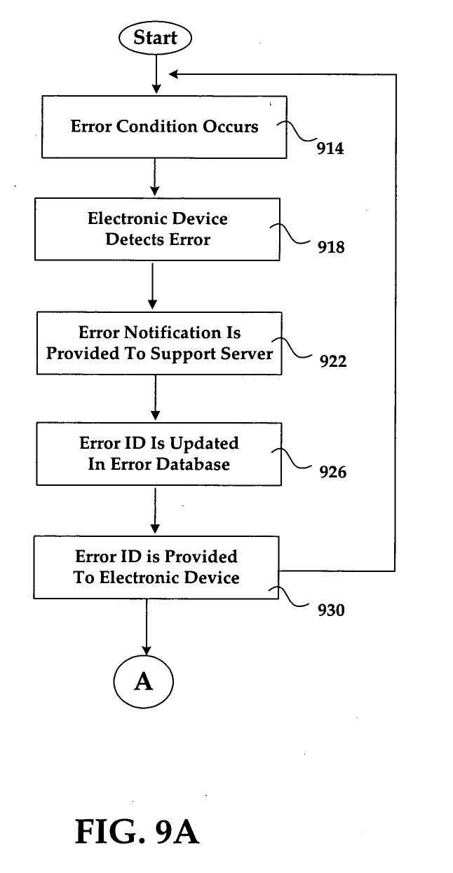

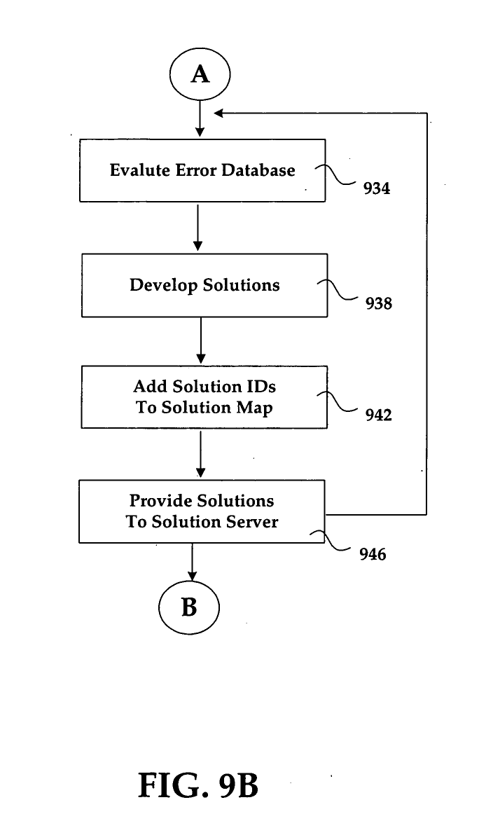

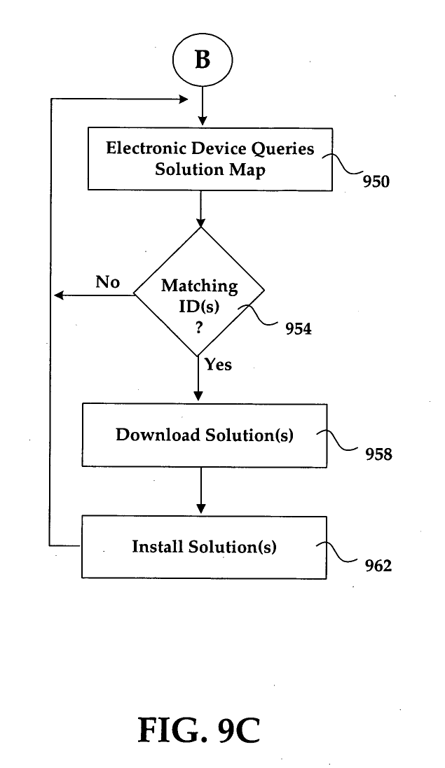

In the FIG. 3 embodiment, support manager 320 may include any effective means for managing automated device support procedures for electronic devices 126 (FIG. 1). For example, support manager 320 may populate an error database 324 with detected errors that are reported from electronic devices 126. Support manager 320 may also assign a unique error ID to each new detected error to populate a solution map 326. In the FIG. 3 embodiment, communication manager 336 may perform appropriate communication functions with electronic devices 126 and solution server 124 to transfer any appropriate type of information. Miscellaneous information 340 may include any additional information that for utilization by electronic device 126. Additional details regarding the operation and implementation of support server 118 are further discussed below in conjunction with FIGS. 4 and 9.

Referring now to FIG. 4, a diagram for one embodiment of the FIG. 4 solution map 326 is shown, in accordance with the present invention. In the FIG. 4 embodiment, solution map 326 includes, but is not limited to, a series of solution mappings 440 that each associate a given error identifier (ID) to a corresponding solution identifier (ID). In alternate embodiments, solution map 326 may include other components and information in addition to, or instead of, certain of those components and information discussed in conjunction with the FIG. 4 embodiment.

In the FIG. 4 embodiment, solution map 326 includes a solution mapping A 440(a) through a solution mapping N 440(n) that each has a corresponding model ID, error ID, and solution ID. For example, the FIG. 4 solution mapping A 440(a) includes a model ID A corresponding to a given electronic device 126, an error ID A corresponding to a detected error on that electronic device 126, and a solution ID A that corresponds to an effective solution for the detected error. In the FIG. 4 embodiment, the identifiers (IDs) may be implemented in any effective manner including, but not limited to a numerical or textual identifier. Additional details regarding the creation and utilization of solution map 326 are further discussed below in conjunction with FIG. 9.

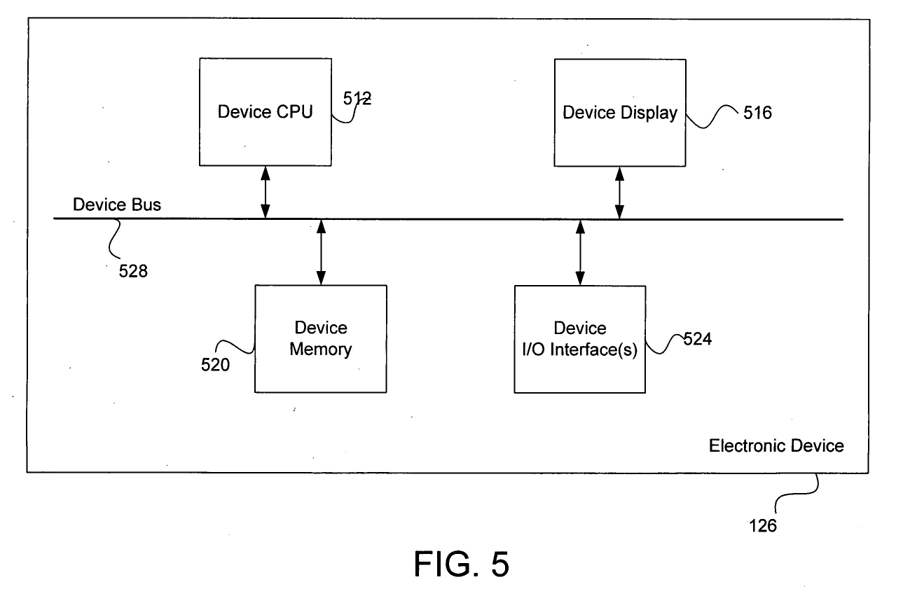

Referring now to FIG. 5, a block diagram for one embodiment of a FIG. 1 electronic device 126 is shown, in accordance with the present invention. In the FIG. 5 embodiment, electronic device 126 may include, but is not limited to, a device central processing unit (device CPU) 512, a device display 516, a device memory 520, and one or more device input/output interface(s) (device I/O interface(s)) 524. The foregoing components of electronic device 126 may be coupled to, and communicate through, a device bus 528.

In alternate embodiments, electronic device 126 may readily be implemented using various components and configurations in addition to, or instead of, certain of those components and configurations discussed in conjunction with the FIG. 5 embodiment. Furthermore, in the FIG. 5 embodiment, electronic device 126 may be implemented as any type of appropriate entity. For example, in certain embodiments, electronic device 126 may be implemented as any type of stationary or portable electronic device, such as a personal computer, a television, a consumer-electronics device, a cellular telephone, a settop box, an audio-visual entertainment device, or a personal digital assistant (PDA).

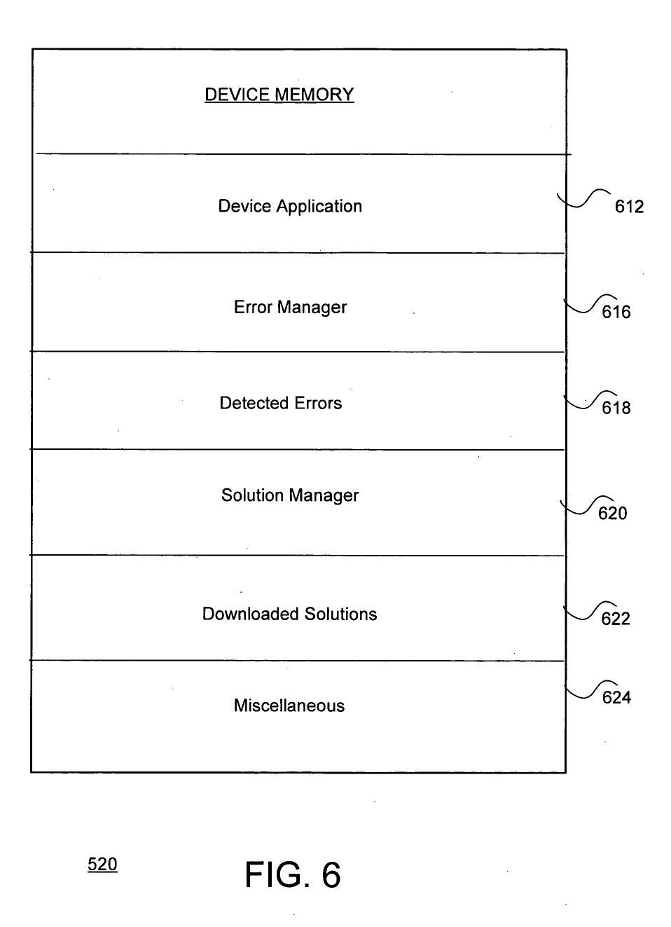

In the FIG. 5 embodiment, device CPU 512 may be implemented to include any appropriate and compatible microprocessor device that preferably executes software instructions to thereby control and manage the operation of client devices 126. The FIG. 5 device display 516 may include any effective type of display technology including a cathode-ray-tube monitor or a liquid-crystal display device with an appropriate screen for displaying various information to a device user. In the FIG. 5 embodiment, device memory 520 may be implemented to include any combination of desired storage devices, including, but not limited to, read-only memory (ROM), random-access memory (RAM), and various types of non-volatile memory, such as floppy disks, memory sticks, compact disks, or hard disks. The contents and functionality of device memory 520 are further discussed below in conjunction with FIG. 6.

In the FIG. 5 embodiment, device I/O interface(s) 524 may include one or more input and/or output interfaces to receive and/or transmit any required types of information by electronic device 126. Device I/O interface(s) 524 may include one or more means for allowing a device user to communicate with other entities in support system 110 (FIG. 1). For example, the foregoing means may include a keyboard device, a wireless remote-control device, a speech-recognition module with corresponding microphone, a graphical user interface with touch-screen capability, a hand-held device controller unit, or a selection button array mounted externally on electronic device 126. The implementation and utilization of electronic device 126 are further discussed below in conjunction with FIGS. 6-7 and 9.

Referring now to FIG. 6, a block diagram for one embodiment of the FIG. 5 device memory 520 is shown, in accordance with the present invention. In the FIG. 6 embodiment, device memory 520 includes, but is not limited to, a device application 612, an error manager 616, detected errors 618, a solution manager 620, downloaded solutions 622, and miscellaneous items 624. In alternate embodiments, device memory 520 may include components and functionalities in addition to, or instead of, certain of those components and functionalities discussed in conjunction with the FIG. 6 embodiment.

In the FIG. 6 embodiment, device application 612 may include program instructions that are preferably executed by a device CPU 512 (FIG. 5) to perform various functions and operations for electronic device 126. The particular nature and functionality of device application 612 typically varies depending upon factors such as the specific type and particular functionality of the corresponding electronic device 126.

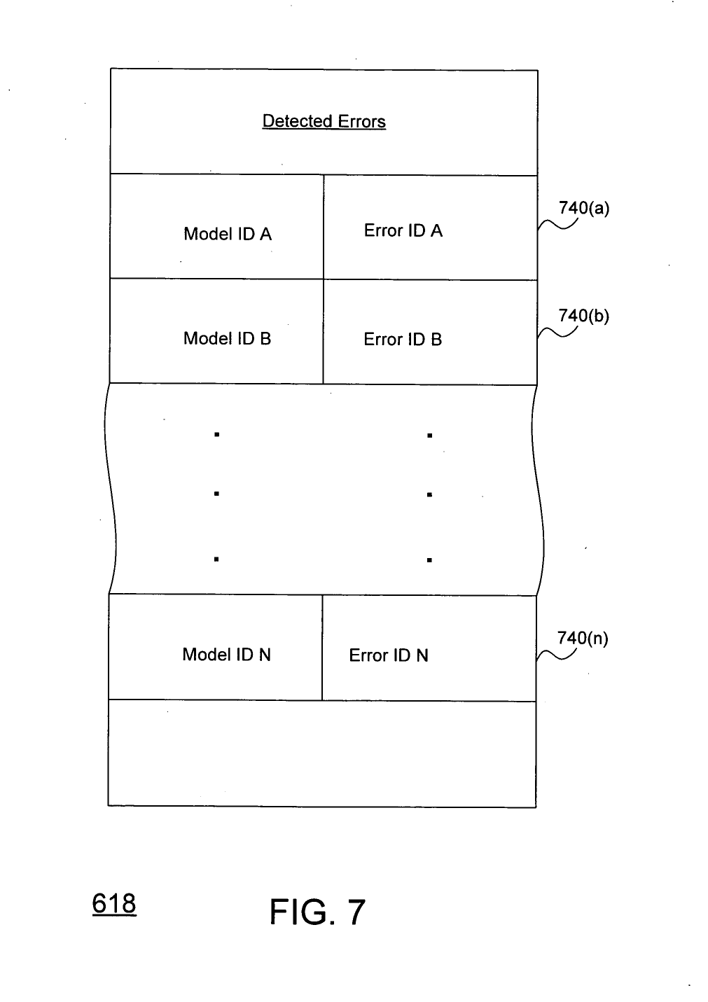

In the FIG. 6 embodiment, error manager 616 may monitor electronic device 126 to sense and record the occurrences of detected errors 618 in any effective manner. One embodiment for detected errors 618 is further discussed below in conjunction with FIG. 7. In the FIG. 6 embodiment, solution manager 620 may automatically access and install downloaded solutions 622 from a solution database in any effective manner. Miscellaneous information 624 may include any additional information that for utilization by electronic device 126. The implementation and utilization of electronic device 126 is further discussed below in conjunction with FIGS. 7 and 9.

Referring now to FIG. 7, a diagram for one embodiment of the FIG. 6 detected errors 618 is shown, in accordance with the present invention. In the FIG. 7 embodiment, detected errors 618 include, but are not limited to, a series of error entries 740 that correspond to error conditions that have been detected by electronic device 126 (FIG. 1). In alternate embodiments, detected errors 618 may include other components and information in addition to, or instead of, certain of those components and information discussed in conjunction with the FIG. 7 embodiment.

In the FIG. 7 embodiment, detected errors 618 include an error entry A 740(a) through an error entry N 740(n) that each has a corresponding model ID and error ID. For example, the FIG. 7 error entry A 740(a) includes a model ID A corresponding to a given electronic device 126, and an error ID A corresponding to a detected error on that electronic device 126. In the FIG. 7 embodiment, the identifiers (IDs) may be implemented in any effective manner including, but not limited to, a numerical or textual identifier. Additional details regarding the utilization of detected errors 618 are further discussed below in conjunction with FIG. 9.

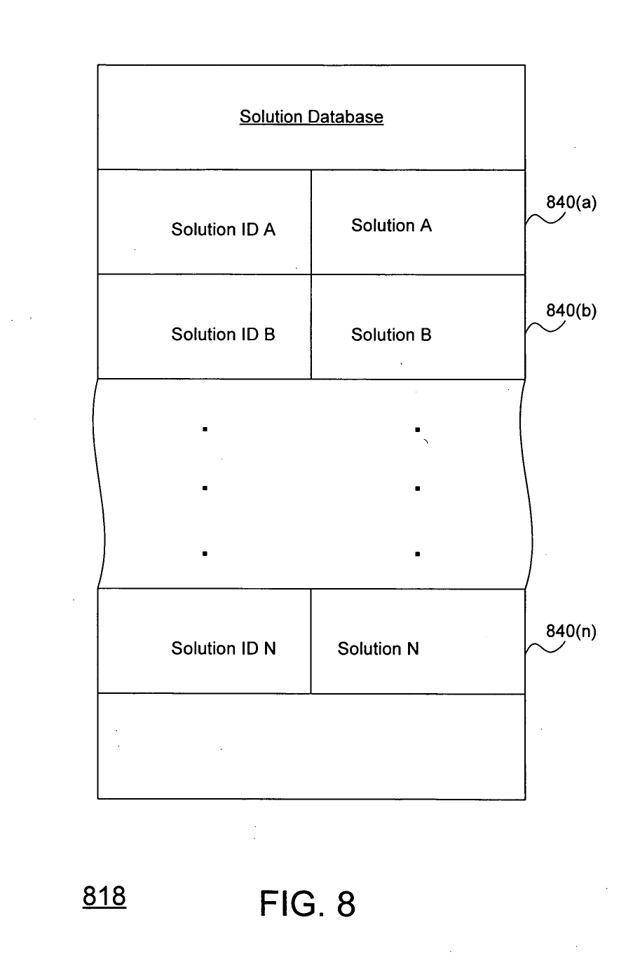

Referring now to FIG. 8, a diagram for one embodiment of a solution database 818 is shown, in accordance with the present invention. In the FIG. 8 embodiment, solution database 818 includes, but is not limited to, a series of solutions 840 that are associated with corresponding solution identifiers (IDs). In alternate embodiments, solution database 818 may include other components and information in addition to, or instead of, certain of those components and information discussed in conjunction with the FIG. 8 embodiment.

In the FIG. 8 embodiment, solution database 818 resides on a solution server 124 (FIG. 1). However, solution database 818 may alternately be managed by any other appropriate entity including, but not limited to, support server 118. In the FIG. 8 embodiment, solution database 818 includes a solution A 840(a) through a solution N 840(n) that each is associated with a corresponding solution ID. For example, the FIG. 8 solution A 840(a) is associated with a solution ID A corresponding to a specific type of detected error 618 on electronic devices 126. In the FIG. 8 embodiment, the solution IDs correspond to identical solution IDs from solution map 326 (FIG. 3). An electronic device 126 may thus utilize an appropriate error ID reference a corresponding solution ID in solution map 326. The electronic device 126 may then utilize the solution ID to identify, download, and install the correct solution 840 for the detected error 618. Additional details regarding the creation and utilization of solution database 818 are further discussed below in conjunction with FIG. 9.

Referring now to FIGS. 9A-9C, a flowchart of method steps for providing automated support to an electronic device is shown, in accordance with one embodiment of the present invention. The FIG. 9 flowchart is presented for purposes of illustration, and in alternate embodiments, the present invention may utilize steps and sequences other than those steps and sequences discussed in conjunction with the FIG. 9 embodiment.

In step 914 of FIG. 9A, an error condition (error) occurs in an electronic device 126 that has authorized access to an automated device support system 110 (FIG. 1). The error may include any type of occurrence, condition, or state that affects the electronic device 126. In step 918, an error manager 616 of the electronic device 126 detects the foregoing error. In step 922, an error notification is provided to a support server 118 of the automated device support system 110 in any effective manner. For example, a device user of the electronic device 126 may manually provide the error notification by any means including, but not limited to, a telephone conversation or an email message. Alternately, error manager 616 may automatically provide the error notification to the support server 118 via an Internet or other type of communication link.

In step 926, a support manager 320 of the support server 118 updates an error database 324 to include a unique error identifier (ID) corresponding to the detected error on the electronic device 126. In step 930, the support server 118 provides a copy of the error ID to the electronic device 126 for local storage in detected errors 616 (FIG. 6). The FIG. 9A process then advances to step 934 of FIG. 9B through connecting letter “A.”

In step 934, support system personnel or other appropriate entities periodically evaluate the error database 324 of the support server 118 to identify any new detected errors. In step 938, the support system personnel or other appropriate entities then work to develop effective solutions 840 for correcting any new detected errors. In step 942, the support manager 320 next performs a mapping procedure to populate a solution map 326 of the support server 118.

In certain embodiments, the solution map 326 maps each error ID to a corresponding solution identifier (ID) that represents an effective solution 840 for the particular detected error. In step 946, the support system personnel or other appropriate entities also store the developed solution 840 in a solution database 818 of a solution server 124 (FIG. 1). The FIG. 9B process then advances to step 950 of FIG. 9C through connecting letter “B.”

In step 950, a solution manager 620 of the electronic device 126 may query the solution map 326 of the support server 118 to determine whether an effective solution is listed for any of the detected errors 618. In step 954 of the FIG. 9C embodiment, the solution manager 620 compares the locally-stored error IDs from detected errors 618 with the error IDs in the solution map 326 of the support server 118. If one or more matching error IDs are identified, then in step 958, the support manager 320 may then utilize solution IDs corresponding to those matching error IDs to identify, access, and download appropriate solutions 840 from the solution database 818 of the solution server 124 (FIG. 1). In step 962, the solution manager 620 then installs the downloaded solutions 840 to effectively repair the detected errors for the electronic device 126. For at least the foregoing reasons, the present invention therefore provides an improved system and method for effectively providing automated support to electronic devices.

The invention has been explained above with reference to certain embodiments. Other embodiments will be apparent to those skilled in the art in light of this disclosure. For example, the present invention may readily be implemented using certain configurations and techniques other than those described in the specific embodiments above. Additionally, the present invention may effectively be used in conjunction with systems other than those described above. Therefore, these and other variations upon the discussed embodiments are intended to be covered by the present invention, which is limited only by the appended claims.

What is claimed is:

1. A system for providing automated support services, comprising:
an electronic device in an electronic network, said electronic device experiencing an error condition;
a support server that receives an error notification regarding said error condition, said support server assigning an error identifier to said error condition; and
a solution database that stores a solution to said error condition, said electronic device automatically downloading and installing said solution to remedy said error condition.

2. The system of claim 1 wherein a support manager of said support server maps said error identifier to a solution identifier in a solution map.

3. The system of claim 2 wherein said support server provides said error identifier to said electronic device for storing locally in a list of detected errors.

4. The system of claim 3 wherein a solution manager of said electronic device retrieves said solution identifier from said solution map by utilizing said error identifier.

5. The system of claim 4 wherein said solution manager of said electronic device locates said solution in said solution database by utilizing said solution identifier.

6. The system of claim 1 wherein said solution database is located on a solution server.

7. The system of claim 1 wherein said electronic device communicates with said support server by utilizing an Internet communication link.

8. The system of claim 1 wherein said electronic device utilizes an error manager to detect said error condition, said error manager automatically providing said error notification to said support server.

9. The system of claim 1 wherein a device user of said electronic device detects said error condition, said device user providing said error notification to said support server.

10. The system of claim 1 wherein said support server records detected errors from a plurality of client devices, said support server mapping error identifiers associated with said detected errors to corresponding solution identifiers in said solution map, said solution database providing said plurality of client devices automatic access to respective solutions for said detected errors.

11. An electronic device that utilizes automated support services, comprising:
an error manager that detects an error condition in said electronic device, said error manager providing an error notification regarding said error condition to a support server that assigns an error identifier to said error condition;
a solution manager that automatically downloads a solution to said error condition from a solution database, said solution manager installing said solution to remedy said error condition; and
a processor that controls said error manager and said solution manager.

12. The electronic device of claim 11 wherein a support manager of said support server maps said error identifier to a solution identifier in a solution map.

13. The electronic device of claim 12 wherein said support server provides said error identifier to said electronic device for storing locally in a list of detected errors.

14. The electronic device of claim 13 wherein a solution manager of said electronic device retrieves said solution identifier from said solution map by utilizing said error identifier.

15. The electronic device of claim 14 wherein said solution manager of said electronic device locates said solution in said solution database by utilizing said solution identifier.

16. The electronic device of claim 11 wherein said solution database is located on a solution server.

17. The electronic device of claim 11 wherein said electronic device communicates with said support server by utilizing an Internet communication link.

18. The electronic device of claim 11 wherein said electronic device utilizes an error manager to detect said error condition, said error manager automatically providing said error notification to said support server.

19. The electronic device of claim 11 wherein a device user of said electronic device detects said error condition, said device user providing said error notification to said support server.

20. The electronic device of claim 11 wherein said support server records detected errors from a plurality of client devices, said support server mapping error identifiers associated with said detected errors to corresponding solution identifiers in said solution map, said solution database providing said plurality of client devices automatic access to respective solutions for said detected errors.
